(19) United States
(12) Patent Application Publication
(10) Pub. No.: US 2007/0180198 A1
(43) Pub. Date: Aug. 2, 2007

(54) Processor for multiprocessing computer systems and a computer system

(75) Inventors: Hidetaka Aoki, Tokyo (JP); Naonobu Sukegawa, Inagi (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/358,052

(22) Filed: Feb. 22, 2006

(30) Foreign Application Priority Data
Feb. 2, 2006 (JP) 2006-25574

(51) Int. Cl. G06F 13/28

(52) U.S. Cl. 711/141

(57) ABSTRACT

When the same data is used in a multiprocessor system, cache misses are reduced to prevent a coherence request from frequently occurring between processors. Provided is a processor including: an interface for performing communication with a main memory or one of the another processor through a system control unit; a cache memory for storing data of the main memory; and a reading processing unit for reading data at an address contained in a reading instruction from the main memory to store the read data in the cache memory, in which the reading processing unit includes: a first load instruction executing unit for reading data corresponding to an address designated by a first load instruction from the main memory and the one of the another processor to store the data into the cache memory; and a second load instruction executing unit for reading data corresponding to an address designated by a second load instruction from the main memory or the one of the another processor to store the data into the cache memory and requesting the system control unit to transmit the data to the another processor

### CLAIM OF PRIORITY

The present application claims priority from Japanese application P2006-25574 filed on Feb. 2, 2006, the content of which is hereby incorporated by reference into this application.

### BACKGROUND OF THE INVENTION

This invention relates to control of a cache memory in a multiprocessor system including a plurality of processors which share a main memory.

In a multiprocessor computer including a plurality of processors which share a main memory, a parallel processing of allowing the plurality of processors to execute the same program (process) is known as an SPMD (Single Program, Multiple Data) processing.

Each of the processors in the multiprocessor system is provided with a cache memory capable of reading and writing data at a higher speed than the main memory. The processor executes an instruction after temporarily storing data or the instruction required for the processing in the cache memory. When the content at the same address (block) is stored in the cache memory of each of the processors, the execution of cache coherence control (Cache Snooping) is known. The cache coherence control is executed so that the contents at the same address are not incoherent between different cache memories, for example, as described in JP 2002-149498 A and JP 2004-192619 A.

### SUMMARY OF THE INVENTION

When the parallel processing via the SPMD is performed in the shared memory multiprocessor system described above, the plurality of processors executing the same program sometimes use the same data. A case where three processors execute the same program and use the same data will now be considered. The same data (for example, data at an address S) has not been stored yet in the cache memory of each of the processors.

First, when a first processor executes an instruction of loading data at the address S from its cache memory, a cache miss occurs because the data at the address S has not been in the cache memory yet. The first processor broadcasts a coherence request (Snooping request) to second and third processors. Since the data at the address S is not present in the second and third processors, the first processor reads the data at the address S from the main memory into the cache memory.

Next, when the second processor executes an instruction of loading data at the address S from its cache memory, a cache miss occurs because the data at the address S has not been in the cache memory yet. The second processor broadcasts a coherence request (Snooping request) to the first and third processors. Since the first processor has the data at the address S, the data is transferred to the cache memory of the first processor to the cache memory of the second processor.

When the third processor executes an instruction of loading data at the address S from its cache memory, a cache miss occurs because the data at the address S has not been in the cache memory yet. The third processor broadcasts a coherence request (Snooping request) to the first and second processors. Since the first processor has the data at the address S, the data at the address S is transferred from the cache memory of the first processor to the cache memory of the third processor.

In the procedure as described above, the same data is stored in the cache memories of the three processors to enable the execution of a predetermined processing.

In the above-mentioned conventional example, when a cache miss occurs during the loading of the same data, each of the processors tries to load the data only into its own cache memory. Therefore, in addition to a load delay of the data due to the cache miss, there also arises a problem in that the processing performance of the computer is degraded by frequently issued coherence requests.

This invention has been made in view of the above problem, and it is therefore an object of this invention to reduce cache misses when the same data is used in a multiprocessor system and to prevent a coherence request from being frequently issued between processors so as to improve the performance of the multiprocessor system.

According to an embodiment of this invention, a computer includes: a plurality of processors, each including a cache memory; and a system control unit connected to the plurality of processors, for controlling an access to a main memory and an access between the processors. In the computer, each of the processors includes: an interface for performing communication with the main memory or another one of the processors through the system control unit; and a reading processing unit for reading data at an address contained in a reading instruction through the system control unit to store the read data in the cache memory, the reading processing unit includes: a first load instruction executing unit for requesting the system control unit for data corresponding to an address designated by a first load instruction to store the data received from the system control unit in the cache memory; and a second load instruction executing unit for requesting the system control unit for data corresponding to an address designated by a second load instruction to store the data received from the system control unit in the cache memory and requesting the system control unit to broadcast the data to the another processor; and the system control unit transmits the data corresponding to the address to the plurality of processors when a broadcast request is made by the second load instruction executing unit.

The plurality of processors execute the same program in parallel in the same group.

Therefore, in this invention, when the second load instruction is executed and data at a designated address is not present in the cache memory, broadcasting is performed so that the data is cached in the plurality of processors. When the plurality of processors process the same program or the same type of program in parallel, an coherence request or an access to the main memory for the data at the same address can be prevented from being frequently made by the plurality of processors to enable the improvement of the performance of the parallel processing.

### BRIEF DESCRIPTION OF THE DRAWINGS

FIG. 1 is a block diagram showing a first embodiment, illustrating a configuration of a computer of a shared memory multiprocessor system to which this invention is applied.

FIG. 2 is a flowchart showing an example of a processing executed in the computer.

FIG. 3 is a block diagram showing a principal configuration of a processor.

FIG. 4 is a flowchart showing an example of a reading processing.

FIG. 5 is a flowchart showing an example of a broadcasting processing 1.

FIG. 6 is an explanatory diagram showing an example of system partitioning information.

FIG. 7 is an explanatory diagram showing a program of a parallel processing via SPMD.

FIG. 8 is an explanatory diagram showing an example of a reading request buffer.

FIG. 9 is an explanatory diagram showing an example of a state change of a reading request buffer by a normal load instruction.

FIG. 10 is an explanatory diagram showing an example of a state change of the reading request buffer by a broadcast hint-included load instruction.

FIG. 11 is an explanatory diagram showing an example of a state change of the reading request buffer when the buffer is full.

FIG. 12 is a flowchart showing a second embodiment, illustrating an example of a processing executed in the computer.

FIG. 13 is a flowchart showing the second embodiment, illustrating an example of a broadcast processing 2.

FIG. 14 is a flowchart showing a third embodiment, illustrating an example of a processing executed in the computer.

FIG. 15 is a flowchart showing the third embodiment, illustrating an example of a broadcast processing 3.

FIG. 16 is a block diagram showing a fourth embodiment, illustrating a configuration of a computer of a shared memory multiprocessor system.

### DETAILED DESCRIPTION OF THE PREFERRED EMBODIMENT

Hereinafter, an embodiment of this invention will be described based on the accompanying drawings.

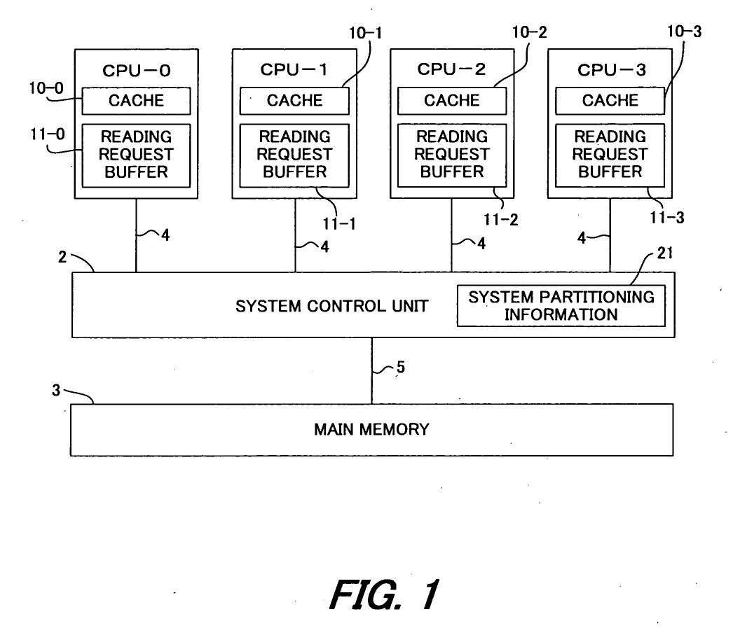

FIG. 1 is a block diagram showing a first embodiment, illustrating a configuration of a computer of a shared memory multiprocessor system to which this invention is applied.

The computer shown in FIG. 1 principally includes a plurality of processors CPU-0 to CPU-3, a main memory 3 for storing a program or data, and a system control unit 2 for performing access control from the processors CPU-0 to CPU-3 to the main memory 3 or an I/O bus (not shown) and the like.

The processor CPU-0 includes a cache memory 10-0 for storing data or an instruction and a reading request buffer 11-0 for managing an address of the data or the instruction to be stored in the cache memory 10-0. The processor CPU-0 processes data on the cache memory 10-0 based on the instruction stored in the cache memory 10-0. For this purpose, the processor CPU-0 includes an instruction executing unit (not shown). In the following description, the cache memory 10-0 is a data cache and independently includes an instruction cache (not shown).

Each of the other processors CPU-1 to CPU-3 is configured in the same manner as the processor CPU-0 to form an SMP (Symmetric Multiple Processor). Similarly to the CPU-0, the processors CPU- 1 to CPU-3 respectively include cache memories 10-1 to 10-3 and reading request buffers 11-1 to 11-3 so as to correspond to the respective subscripts -1 to -3. Each of the cache memories 10-0 to 10-3 includes a plurality of cache lines (not shown).

The system control unit 2 and the processors CPU-0 to CPU-3 are connected through frontside buses 4, while the system control unit 2 and the main memory 3 are connected through a memory bus 5.

The system control unit 2 reads and writes data from/to the main memory 3 in accordance with a request from the processors CPU-0 to CPU-3. The system control unit 2 includes partitioning information 21 for grouping the plurality of processors CPU-0 to CPU-3 and allocates a computer including the CPU-0 to CPU-3 based on the system partitioning information 21. The allocation based on the system partitioning information 21 is, for example, logical partitioning (or physical partitioning). In the following example, the processors CPU-0 to CPU-2 are included in a virtual computer #0, while the processor CPU-3 is included in a virtual computer #1. The system control unit 2 makes an I/O access through a bus (not shown) in response to a request from the processors CPU-0 to CPU-3. The system control unit 2 can be configured with, for example, a north bridge, a memory control hub, or the like.

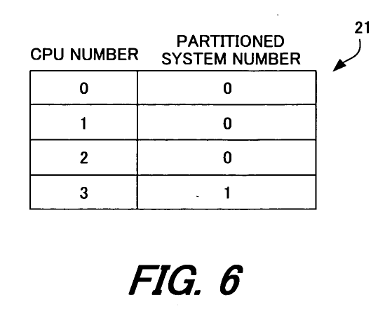

The system partitioning information 21 contains, as shown in FIG. 6, a number of a processor (a CPU number shown in FIG. 6) included in the computer and a system number (for example, a logical partition number in the case of the virtual computer). The system partitioning information 21 is set by a middleware, a management tool (not shown), or the like. When the computer shown in FIG. 1 constitutes a virtual computer, in the example of FIG. 6, the processors CPU-0 to CPU-2 are included in the virtual computer #0, while the processor CPU-3 is included in the virtual computer #1.

The virtual computer #0 executes a parallel processing via SPMD (Single Program, Multiple Data).

<An Example of Processing>

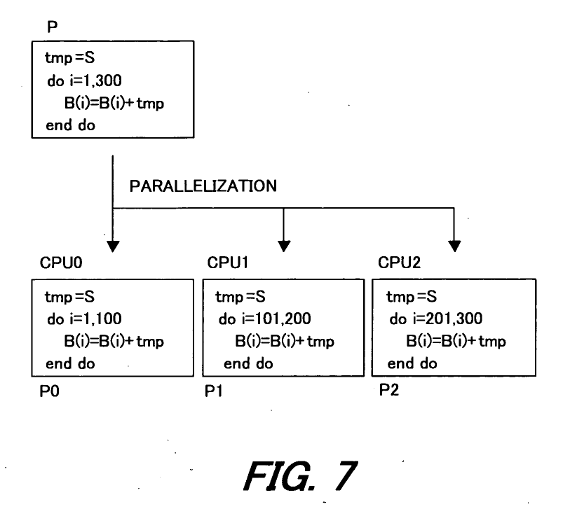

An example of a program P executed in the virtual computer #0 is shown in FIG. 7. The program P corresponds to a processing of adding a constant tmp=S to an array B(i) 300 times, where “S” represents an address in the main memory 3. Each of the processors CPU-0 to CPU-2 is made to execute in parallel the same type of programs P0 to P2 obtained by partitioning a computing range. The processors CPU-0 to CPU-2 are parallelized so that the program P0 executes the computation of the above-mentioned array B(i) for i=1 to 100, the program P1 executes the computation of the above-mentioned array B(i) for i=101 to 200, and the program P2 executes the computation of the above-mentioned array B(i) for i=201 to 300. The programs P0 to P2 are simultaneously executed by the processors CPU-0 to CPU-2 to realize the parallel processing.

<Instruction Sets in the Processors>

Next, instruction sets preset in the processors CPU-0 to CPU-3 will be described below. The instruction sets in the processors CPU-0 to CPU-3 are roughly classified as follows. Specifically, a load instruction group for reading data required for a computation in the register, a prefetch instruction group for reading required data prior to the execution of the load instruction from the main memory 3 to the cache memories 10-0 to 10-3, a store instruction group for writing the result of computation stored in the register into the main memory 3. An instruction executing unit (described below) for executing the above instruction groups and the other instruction groups for performing a computation such as addition, subtraction, multiplication, and division and a computation of a bit operation is provided.

(1) Load Instruction Group

The load instruction group includes a normal load instruction and a broadcast hint-included load instruction of broadcasting data to be loaded to another processor in the same group upon a cache miss. When data at the address required by the load instruction or the broadcast hint-included load instruction is stored in the cache memories 10-0 to 10-3, a cache hit occurs. If not, a cache miss occurs.

Normal Load Instruction

For a cache hit: Data at a corresponding address is read from the cache memories 10-0 to 10-3 to be set in the register.

For a cache miss: An address to be requested is set in the reading request buffers 11-0 to 11-3 to request the system control unit 2 to read data from the main memory 3. When the data at the requested address is read, a corresponding entry of each of the reading request buffers 11-0 to 11-3 is cleared as described below to set the read data in the register.

Broadcast Hint-included Load Instruction

For a cache hit: Data at a corresponding address is read from the cache memories 10-0 to 10-3 to be set in the register (as in the case of the normal load instruction).

For a cache miss: An address to be requested is set in the reading request buffers 11-0 t0 11-3 to request the system control system 2 for a broadcast request and to read data from the main memory 3. The system control unit 2 refers to the system partitioning information 21 to broadcast the load request to the processors in the same group (in the same logical partition). When the data at the requested address is read, a corresponding entry of each of the reading request buffers 11-0 to 11-3 is cleared as described below. After being stored in the cache memories 10-0 to 10-3, the read data is set in the register.

(2) Prefetch Instruction Group

The prefetch instruction group includes a normal prefetch instruction and a broadcast hint-included prefetch instruction of broadcasting data to be prefetched to another processor in the same group upon a cache miss.

Normal Prefetch Instruction

For a cache hit: No processing.

For a cache miss: An address to be requested is set in the reading request buffers 11-0 to 11-3 to request the system control unit 2 to read data from the main memory 3. When the data at the requested address is read, a corresponding entry in each of the reading request buffers 11-0 to 11-3 is cleared as described below to store the read data in the cache memories 10-0 to 10-3.

Broadcast Hint-included Prefetch Instruction

For a cache hit: No processing (as in the case of the normal prefetch instruction).

For a cache miss: An address to be requested is set in the reading request buffers 11-0 to 11-3 to request the system control unit 2 to broadcast and read data from the main memory 3. The system control unit 2 refers to the system partitioning information 21 to broadcast the prefetch request to the processors in the same group (in the same logical partition). When the data at the requested address is read, a corresponding entry of each of the reading request buffers 11-0 to 11-3 is cleared as described below. Then, the read data is set in the register.

(3) Store Instruction Group

The store instruction group includes a normal store instruction and a broadcast hint-included store instruction of broadcasting data to be stored to another processor in the same group upon a cache miss.

Normal Store Instruction

For a cache hit: Data at a corresponding address of the cache memory is updated to the content in the register. The processors CPU-0 to CPU-3 requests the system control unit 2 to snoop the other processors in the same group.

For a cache miss: The address at which the content of the register is to be written is set in each of the reading request buffers 11-0 to 11-3 to request the system control unit 2 to write data to the main memory 3. When the system control unit 2 writes the data at the requested address, a corresponding entry in the reading request buffers 11-0 to 11-3 is cleared as described below. The processors CPU-0 to CPU-3 request the system control unit 2 to snoop the other processors in the same group.

Broadcast Hint-included Store Instruction

For a cache hit: As in the case of the normal store instruction.

For a cache miss: An address at which the content of the register is to be written is set in the reading request buffers 11-0 to 11-3 to request the system control unit 2 to write data to the main memory 3. The processors request the system control unit 2 to broadcast the store instruction. The system control unit 2 refers to the system partitioning information 21 to broadcast the store request to the processor in the same group (in the same logical partition). When the system control unit 2 writes the content of the register to the requested address of the main memory 3, the system control unit 2 broadcasts the written data to the processors in the same group. Each of the processors clears a corresponding entry of the reading request buffer. The other processors update the corresponding data in the cache memories to perform snooping.

<Reading Request Buffers>

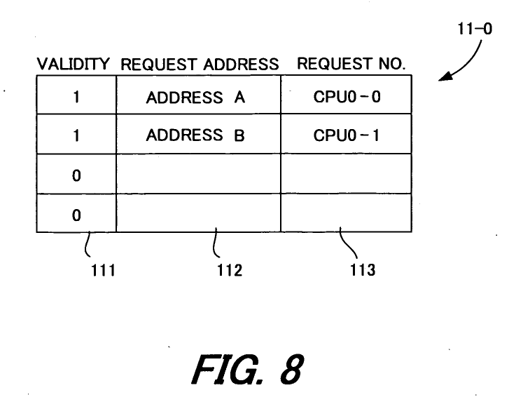

Next, the reading request buffers 11-0 to 11-3 respectively provided for the processors CPU-0 to CPU-3 will be described. FIG. 8 shows an example of the reading request buffer 11-0 provided for the processor CPU-0. Each of the reading request buffers 11-1 to 11-3 of the processors CPU-1 to CPU-3 is the same as the processor CPU-0.

The reading request buffer 11-0 includes a predetermined number of entries (in this example, four entries). Each entry has a validity flag 111 indicating whether or not the entry is in use, a request address 112 for storing an address in the main memory 3 making a reading request to the system control unit 2, and a request No. 113 for storing a request identifier of the processor issuing the reading request to the request address 112. As a value of the validation flag 111, “1” indicates that the entry is in use, while “0” indicates that the entry is not in use.

The number of entries of each of the reading request buffers 11-0 to 11-3 may be appropriately set. The request No. 113 may be any number as long as it is unique in the reading request buffer of the processor issuing the request. In this example, the numbers 0 to 3 indicating the order of requests are added to the identifiers (the CPU numbers) of the processors CPU-0 to CPU-3. The numbers indicating the order of requests may be set in accordance with the number of entries of each of the reading request buffers 11-0 to 11-3.

When a cache miss occurs after the load instruction, the broadcast hint-included load instruction or the like and the processor CPU-0 requests, for example, the system control unit 2 to read an address A in the main memory 3, the request address and a request No. are written in the first entry of the reading request buffer 11-0 shown in FIG. 8. Upon reception of the requested data from the system control unit 2, the processor CPU-0 compares the address of the received data and the request address in the reading request buffer 11-0 with each other to clear the content of the entry containing the address identical with that of the received address. Then, the processor CPU-0 sets the validity flag 111 to 0 to allow new writing. Instead of the comparison of the addresses, the request No. accompanying the data and the request No. in the reading request buffer 11-0 may be compared with each other to clear the content of the entry having the value of the request No. identical with the request No. of the data. Also in this case, the validity flag 111 is set to 0 to allow new writing.

<Details of a Reading Processing>

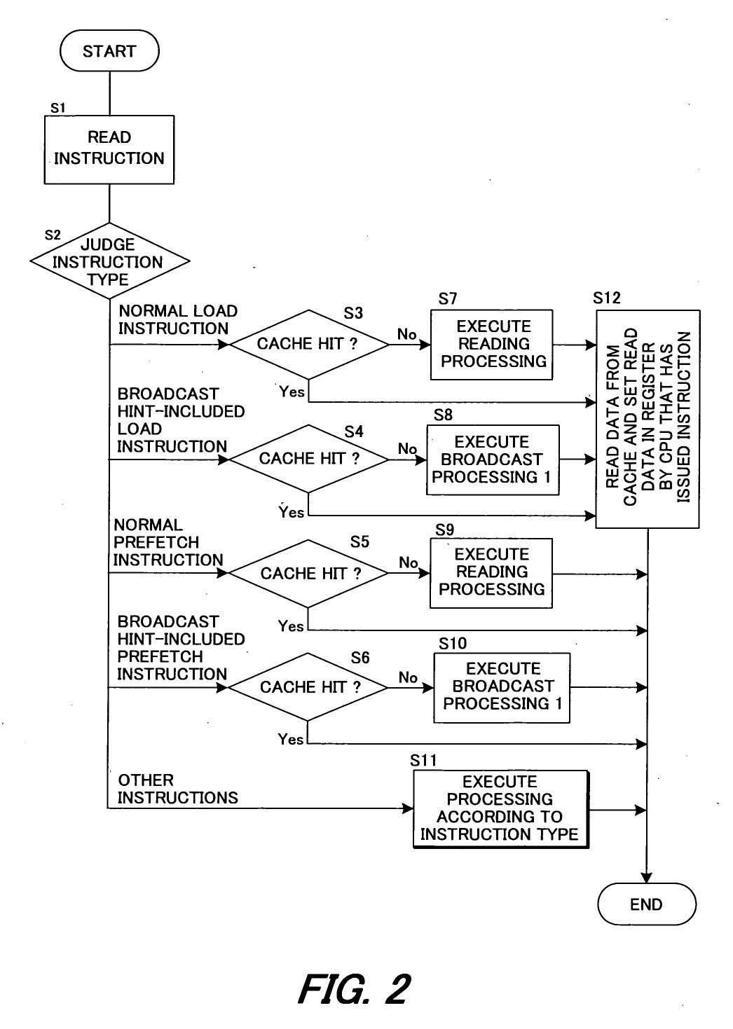

Next, referring to FIG. 2, an example of processings (the load or the prefetch) executed in the processors and the system control unit will be described. In this example, the processors CPU-0 to CPU-2 allocated to the virtual computer #0 execute the parallel processing shown in FIG. 7 based on the system partitioning information 21 shown in FIG. 6. Since the processors CPU-0 to CPU-2 execute the programs P0 to P2 in the same flow, only the processor CPU-0 will be described below. The processing shown in FIG. 2 shows a process flow executed by the processor CPU-0 for each instruction.

First, in Step S1, the processor CPU-0 reads an instruction from the instruction cache. Then, in Step S2, the type of instruction is judged. When the instruction read by the processor CPU-0 is a normal load instruction as a result of judgment of the type of instruction, the processing proceeds to Step S3. When the instruction is a broadcast hint-included load instruction, the processing proceeds to Step S4. When the instruction is a normal prefetch instruction, the processing proceeds to Step S5. When the instruction is a broadcast hint-included prefetch instruction, the processing proceeds to Step S6. In the case of the other instructions (a computation instruction and the like), the processing proceeds to Step S9 to execute the processing in accordance with the instruction.

<Normal Load Instruction and Normal Prefetch Instruction>

In the case of the normal load instruction, it is judged in Step S3 whether or not data at the address designated by the normal load instruction in Step S3 is present in the cache memory 10-0. When a cache hit occurs, the processing proceeds to Step S12 to set the corresponding data in the cache memory 10-0 to a predetermined register (not shown) of the processor CPU-0, thereby completing the instruction.

On the other hand, when a cache miss occurs, the processing proceeds to Step S7 to execute a reading processing from the main memory 3 or another processor in the same group. Thereafter, the processing proceeds to Step S12 to set the read data in a predetermined register to complete the instruction.

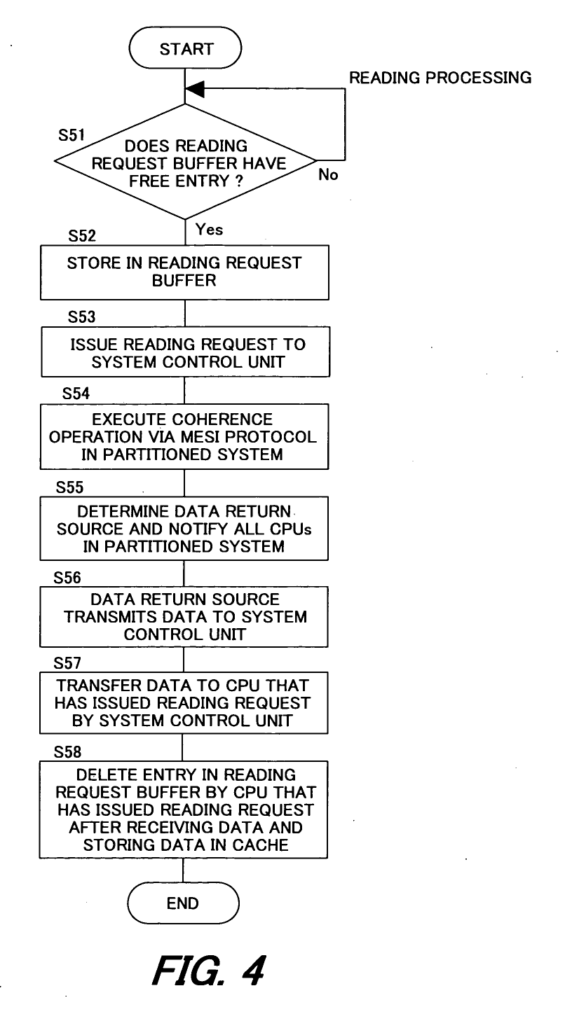

In this step, the reading processing in response to the normal load instruction is executed as shown in FIG. 4. First, the processor CPU-0 judges in Step S51 whether or not the reading request buffer 11-0 has a free entry. Specifically, an entry with the validity flag 111 of “0” is searched from the reading request buffer 11-0 shown in FIG. 8. When all the entries are in use, the processor CPU-0 waits until any one of the entries is no longer in use.

When a free entry appears, the processing proceeds to Step S52 to set the address of the main memory 3 requesting the reading as the request address 112 in the reading request buffer 11-0. After the request No. 113 of a predetermined order is set, the validity flag 111 is updated to “1” to put the entry in use. However, when the same address has already been set in the reading request buffer 11-0, the request is discarded not to write the address to the free entry.

In Step S53, the processor CPU-0 issues a reading request for a predetermined address in the main memory 3 to the system control unit 2.

In Step S54, the system control unit 2 executes coherence control (Cache Snooping) of the cache memories between the processors in the virtual computer (logical partition) including the processor transmitting the reading request. In this example, the system control unit 2 refers to the system partitioning information 21 to control the data at the same address so as to generate any incoherence in accordance with the presence/absence of the values of the cache memories 10-1 and 10-2 holding the data of the address requested by the processor CPU-0 and the update/non-update of the data in the cache memories 10-0 to 10-2 of the processors CPU-0 to CPU-2 in the same group (the virtual computer #0).

For the coherence control, for example, a known MESI protocol may be used. In this MESI protocol, a state where the cache lines of the cache memories 10-0 to 10-3 are invalid is an Invalid state, a state where the cache lines are valid and only its own cache memory has the same data as that of the main memory 3 is an Exclusive state, a state where the cache lines are valid and the data at the same address is also cached in the cache memory of another one of the processors is a Shared state, and a state where the content is valid but rewritten is a Modified state. When another one of the processors reads data from the address in the modified state, the processor which caches the data in the Modified state writes again the content of the cache line to modify the state into the Shared state. In this manner, each of the cache memories 10-0 to 10-2 in the same group ensures the coherence of the data at the same address. The coherence control may also use an MOSEI protocol including an Owned state in addition to the above-mentioned states.

Next, in Step S55, as a result of the coherence control, the system control unit 2 determines that a data return source of the address requested by the processor CPU-0 is the main memory 3 or another one of the processors which caches the data and then notifies the processors CPU-0 to CPU-2 in the same group of the return source. In Step S56, the system control unit 2 receives the data at the corresponding address from the above-mentioned determined return source. Then, in Step S57, the system control unit 2 transfers data to the processor CPU-0 having issued the reading request.

In Step S58, the processor CPU-0 receiving the data at the requested address from the system control unit 2 stores the received data in the cache memory 10-0. Then, the processor CPU-0 deletes the content of the corresponding entry in the reading request buffer 11-0, updates the validity flag 111 to “0”, and puts the entry in an unused state, thereby completing the processing.

For the normal load instruction, in the above-mentioned processing shown in FIG. 4, after the processor CPU-0 reads data from the main memory 3 or one of the other processors CPU-1 and CPU-2 and only the processor CPU-0 having issued the request stores the data in the cache memory 10-0, the processing proceeds to Step S12 to set the data stored in the cache memory 10-0 in a predetermined register. In this manner, the instruction is completed.

The normal prefetch instruction executed in Steps S5 and S9 shown in FIG. 2 is the same as the normal load instruction described above except that the setting to the register is omitted.

The normal store instruction is for writing data in the reverse direction to that of the above-mentioned normal load instruction. The use of the reading request buffers 11-0 to 11-2 is performed in the same manner as in the above-mentioned normal load instruction.

<Broadcast Hint-included Load Instruction and Prefetch Instruction>

When the type of instruction is judged as being the broadcast hint-included load instruction in Step S2 shown in FIG. 2 above, it is judged in Step S4 whether or not data at the address designated by the broadcast hint-included load instruction in Step S4 is present in the cache memory 10-0. When a cache hit occurs, the processing proceeds to Step S12 to set the corresponding data in the cache memory 10-0 in a predetermined register of the processor CPU-0, thereby completing the instruction.

On the other hand, when a cache miss occurs, the processing proceeds to Step S8 to execute a broadcast processing 1 to read the data at the requested address into the cache memory 10-0. Thereafter, the processing proceeds to Step S12 to set the read data in a predetermined register to complete the instruction.

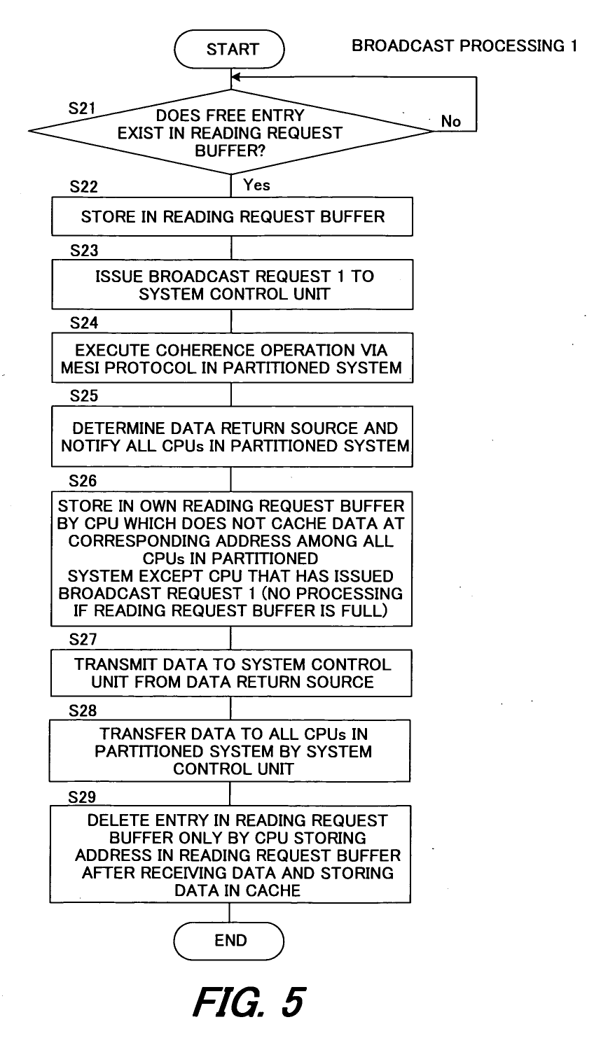

The broadcast processing 1 in response to the broadcast hint-included load instruction is executed as shown in FIG. 5. First, the processor CPU-0 judges in Step S21 whether or not the reading request buffer 11-0 has a free entry. When the reading request buffer 11-0 has a free entry, the processing proceeds to Step S22 to set the address of the main memory 3, which is requested to be read, to the reading request buffer 11-0. However, when the same address has already been set, the request is discarded so as not to write the data to the free entry. The processing of Steps S21 and S22 are the same as those in Steps S51 and S52 shown in FIG. 4.

Next, in Step S23, the processor CPU-0 issues a broadcast request 1 for notifying the processors in the same group of the reading request for the predetermined address of the main memory 3 to the system control unit 2.

In Step S24, as in Step S54 shown in FIG. 4 above, the system control unit 2 executes coherence control of the cache memories in the same group.

Next, in Step S25, as in Step S55 shown in FIG. 4 above, the system control unit 2 determines that the return source of the data at the address requested by the processor CPU-0 is the main memory 3 or another one of the processors which caches the data to notify the processors CPU-0 to CPU-2 in the same group of the return source.

Then, in Step S26, based on the broadcast request 1 received from the processor CPU-0, the system control unit 2 refers to the system partitioning information 21 to broadcast the request address and the request No. to the other processors in the same group. Specifically, the system control unit 2 broadcasts the request address of the cache memory 10-0 of the processor CPU-0 and the request number of the processor CPU-0 to the processors CPU-1 and CPU-2 in the same group except for the processor CPU-0 having issued the broadcast request 1.

When the processors CPU-1 and CPU-2 in the same group, which receive the broadcast request 1 from the system control unit 2, do not cache the data at the corresponding address, the processors CPU-1 and CPU-2 set the content requested by the processor CPU-0 in the free entries of their own reading request buffers 11-1 and 11-2. When there is no free entry (buffer full), the processors CPU-1 and CPU-2 perform no processing.

Through the above processing, when the processors CPU-0 to CPU-2 in the same group, which execute the parallel processing, do not cache the data at the address requested by the processor CPU-0, the address requested by the processor CPU-0 and the request No. of the processor CPU-0 are set in the reading request buffers 11-0 to 11-2.

Next, in Step S27, the system control unit 2 receives the data at the corresponding address from the above-mentioned determined return source. Then, in Step S28, the system control unit 2 transmits the received data to all the processor CPU-0 to CPU-2 in the same group.

In Step S29, among the processors CPU-0 to CPU-2 in the same group, which have received the data at the address requested by the processor CPU-0 from the system control unit 2, any of the processors CPU-0 to CPU-2, which sets the address in its reading request buffer 11-0, 11-1, or 11-2, stores the data in the cache memory 10-0, 10-1, or 10-2. Then, each of the processors CPU-0 to CPU-2 deletes the content of the corresponding entry in the reading request buffers 11-0 to 11-2, updates the validity flag 111 to “0”, and modifies the state of the entry into an unused state, thereby completing the processing.

For the broadcast hint-included load instruction, the data at the address requested by the processor CPU-0 in the above-mentioned processing of FIG. 5 is transferred to all the processors CPU-0 to CPU-2 in the same group so as to store the same data in the cache memories 10-0 to 10-2 in the same group. Specifically, when one of the processors in the same group issues the broadcast hint-included load instruction, it becomes possible to register the same data in the cache memories 10-0 to 10-2 in the same group.

By using the broadcast hint-included load instruction for the parallel processing having a high possibility of using the same data almost at the same time as shown in FIG. 7, it becomes possible to prevent coherence requests from being frequently made between the processors to reduce cache misses when the same data is used in the multiprocessor system.

The broadcast hint-included prefetch instruction executed in Step S6 and S10 shown in FIG. 2 is the same as the broadcast hint-included prefetch instruction described above except that the setting to the register in Step S12 is omitted.

The broadcast hint-included store instruction is for writing data in the reverse direction to that of the above-mentioned broadcast hint-included load instruction. The use of the reading request buffers 11-0 to 11-2 is performed in the same manner as in the above-mentioned broadcast hint-included load instruction.

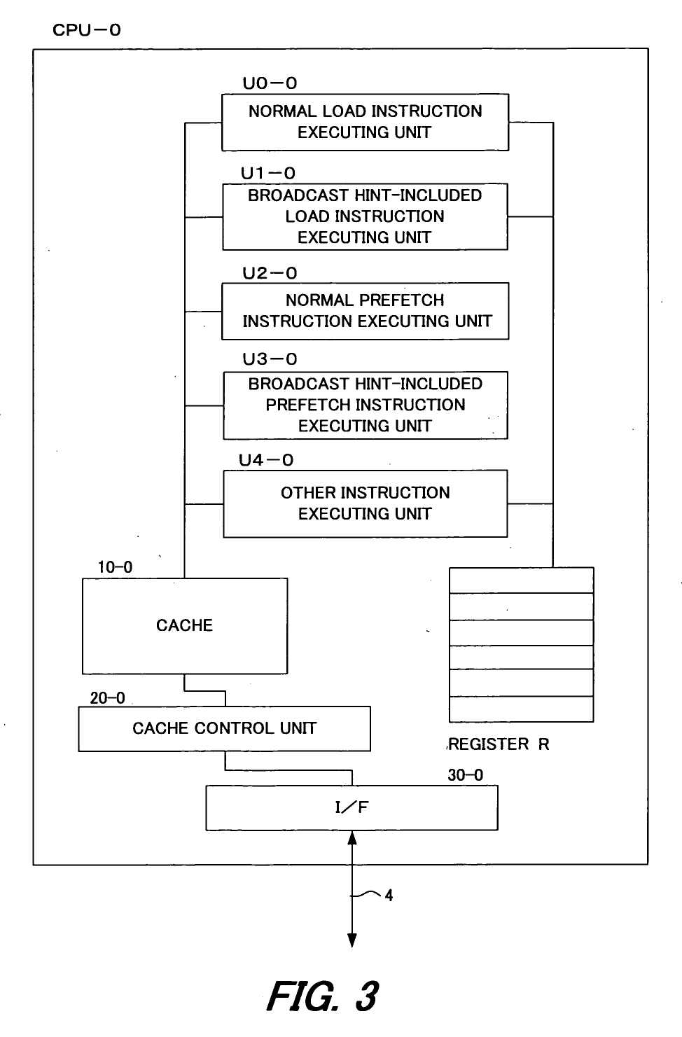

The normal load instruction, the normal prefetch instruction, the broadcast hint-included load instruction, the broadcast hint-included prefetch instruction, and the other instructions are processed in the instruction executing units of the processors CPU-0 to CPU-3. The instruction executing unit of the processor CPU-0 can be schematically shown as in FIG. 3. Each of the processors CPU-1 to CPU-3 has the same configuration.

In FIG. 3, a representative instruction executing unit of the processor CPU-0 includes a normal load instruction executing unit U0-0 for processing the normal load instruction of setting the data read into the cache memory 10-0 to the register R, a broadcast hint-included load instruction executing unit U1-0 for processing the broadcast hint-included load instruction of issuing a broadcast request in accordance with a condition for reading the data into the cache memory 10-0 and setting the read data in the register R, a normal prefetch instruction executing unit U2-0 for processing a normal prefetch instruction of reading the data into the cache memory 10-0, a broadcast hint-included prefetch instruction executing unit U3-0 for processing a broadcast hint-included prefetch instruction for issuing a broadcast request in accordance with a condition for reading data into the cache memory 10-0, and an other instruction executing unit U4-0 for executing the other instructions.

The cache memory 10-0 is managed by a cache control unit 20-2 including the reading request buffer 11-0, for managing the writing to or the reading from the cache memory 10-0. The cache control unit 20-0 is connected to the frontside bus 4 through an interface 30-0 so as to be able to-access the other processors and the main memory 3 through the system control unit 2.

<Applying of the Broadcast Hint-included Instruction to the Parallel Processing>

The case where the broadcast hint-included load instruction (or prefetch instruction) is applied to the parallel processing, in which the programs P0 to P2 obtained by partitioning the program P for each of the computation partitions as shown in FIG. 7 above are processed in parallel by the processors CPU-0 to CPU-2 in the same group, will be described below.

Each of the parallelization programs P0 to P2 is described to add the variable tmp to the array B 100 times after loading the address S of the main memory 3 to the variable tmp. The variable tmp ensures an area on the register. The case where the normal load instruction is used for loading the data at the address S into the variable tmp will be as follows.

Since the processors CPU-0 to CPU-2 do not read the data at the address S into their own cache memories 10-0 to 10-3, the data at the address S of the main memory 3 is read from the system control unit 2 after a coherence request is issued as a result of cache misses sequentially caused by the processors CPU-0 to CPU-2 as described above as the problem. Therefore, three accesses to the main memory 3 and three coherence requests occur.

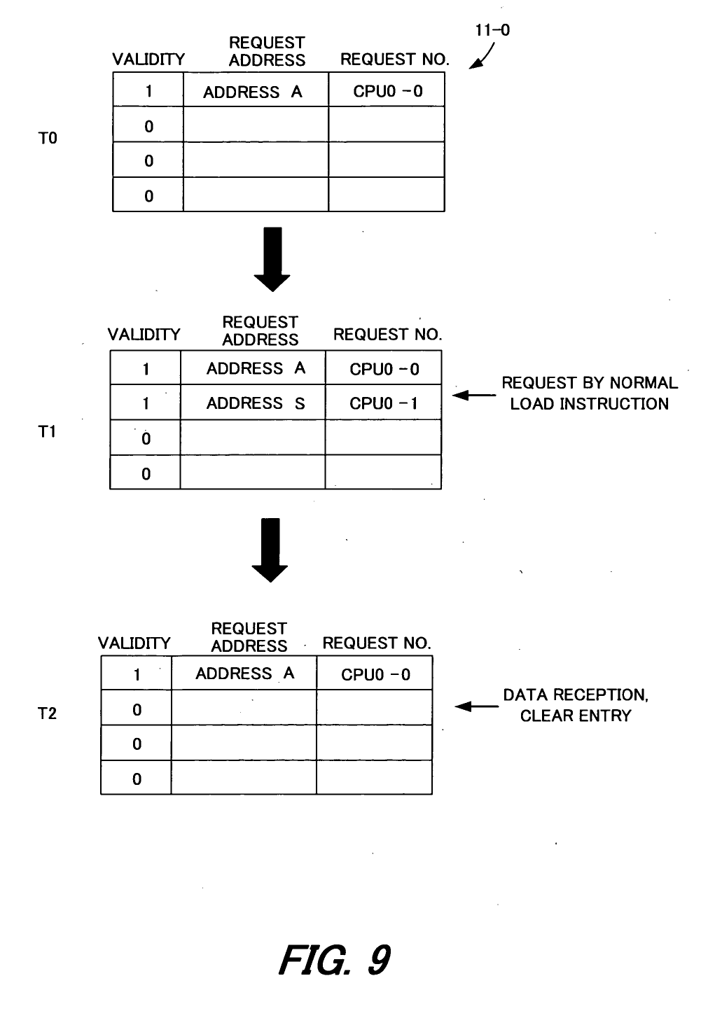

At this time, the content in each of the reading request buffers 11-0 to 11-2 of the processors CPU-0 to CPU-2 changes as shown in FIG. 9. FIG. 9 shows the reading request buffer 11-0 of the processor CPU-0. The reading request buffers 11-1 and 11-2 of the other processors are the same as the reading request buffer 11-0.

In FIG. 9, at a start time T0 of the program P0, the processor CPU-0 has already issued a reading request of the address A. Then, when the processor CPU-0 executes the normal load instruction for the address S at a time T1, a cache miss occurs.

In the reading processing of Step S7 shown in FIG. 2 above, the processor CPU-0 sets the address S and the request No. in the free entry in the reading request buffer 11-0 and sets the validity flag to 1. The processor CPU-0 repeatedly uses the request Nos. -0 to -3 in accordance with the number of entries in the reading request buffer 11-0.

Then, at a time T2, when the data at the address S requested by the processor CPU-0 is transmitted from the system control unit 2, the processor CPU-0 writes the data in the cache memory 10-0 and clears the entry of the corresponding address S in the reading request buffer 11-0 because the data address is S.

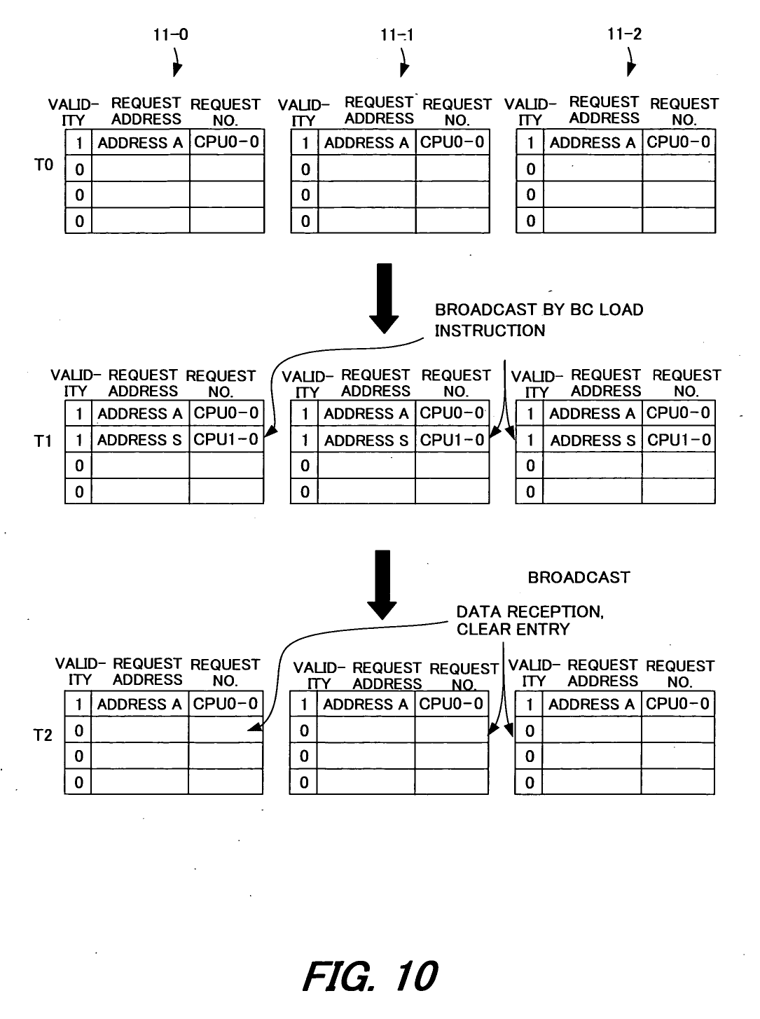

Next, upon loading of the data at the address S to the variable tmp in the programs P0 to P2 in the above-mentioned parallel processing, when the broadcast hint-included load instruction is used, the state of each of the reading request buffers 11-0 to 11-2 of the respective processors CPU-0 to CPU-2 changes as shown in FIG. 10. In the example shown in FIG. 10, the execution time of the processor CPU-1 is earlier than those of the other processors CPU-0 and CPU-2.

In FIG. 10, at the start time T0 of the programs P0 to P2, the processor CPU-0 has already broadcasted the reading request for the address A. Then, at the time T1, the processor CPU-1 executes the broadcast hint-included load instruction for the address S prior to the other processors CPU-0 and CPU-2. Since the processor CPU-1 does not cache the data at the address S, a cache miss occurs.

In the broadcast processing of Step S8 shown in FIG. 2 above, since the system control unit 2 determines the main memory 3 as the return source as a result of the coherence control because the other processors CPU-0 and CPU-2 in the same group do not cache the corresponding data.

At the time T1, the system control unit 2 broadcasts the address S of the reading request and the request No. 1 of the processor CPU-1 to each of the processors CPU-0 to CPU-2. Each of the processors CPU-0 to CPU-2 sets the address S and the request No. CPU1-0 in the free entry in each of the reading request buffers 11-0 to 11-2 and sets the validity flag to 1.

Then, at the time T2, the data at the address S requested by the processor CPU-1 is broadcasted from the system control unit 2 to all the processors CPU-0 to CPU-2 in the same group.

Each of the processors CPU-0 to CPU-2 receiving the data at the address S writes the data in the cache memories 10-0 to 10-2 because the address of the data is S. Then, the entry of the corresponding address S in each of the reading request buffers 11-0 to 11-2 is cleared.

Then, each of the processors CPU-0 to CPU-2 starts a next computation processing of the programs P0 to P2.

Since the processors CPU-0 and CPU-2 execute the same processing with some delay at the time T2, a request of the broadcast hint-included load instruction is attempted to be stored in the reading request buffer 11-0 when a cache miss of the data at the address S occurs. However, since the processors CPU-0 and CPU-2 store the reading request (address S) of the processor CPU-1, which is transmitted from the system control unit 2, in the reading request buffers 11-0 and 11-2, the request for the same address S is discarded without being stored.

Therefore, even when the broadcast hint-included load instruction is used for the parallel processing, the processors CPU-0 to CPU-2 in the same group do not conflict with each other for the data at the same address S.

As described above, in the shared memory multiprocessor system performing the parallel processing, when a cache miss results from the broadcast hint-included instruction by using the broadcast hint-included load instruction (or the broadcast hint-included prefetch instruction or the broadcast hint-included store instruction), broadcasting is performed so that the cache line is cached by all the processors in the same group. Thus, the processors CPU-0 to CPU-2 in the same group can be prevented from frequently making a coherence request or an access to the main memory 3 for the data at the same address S as happens in the above-mentioned conventional example, thereby making it possible to improve the performance of the parallel processing.

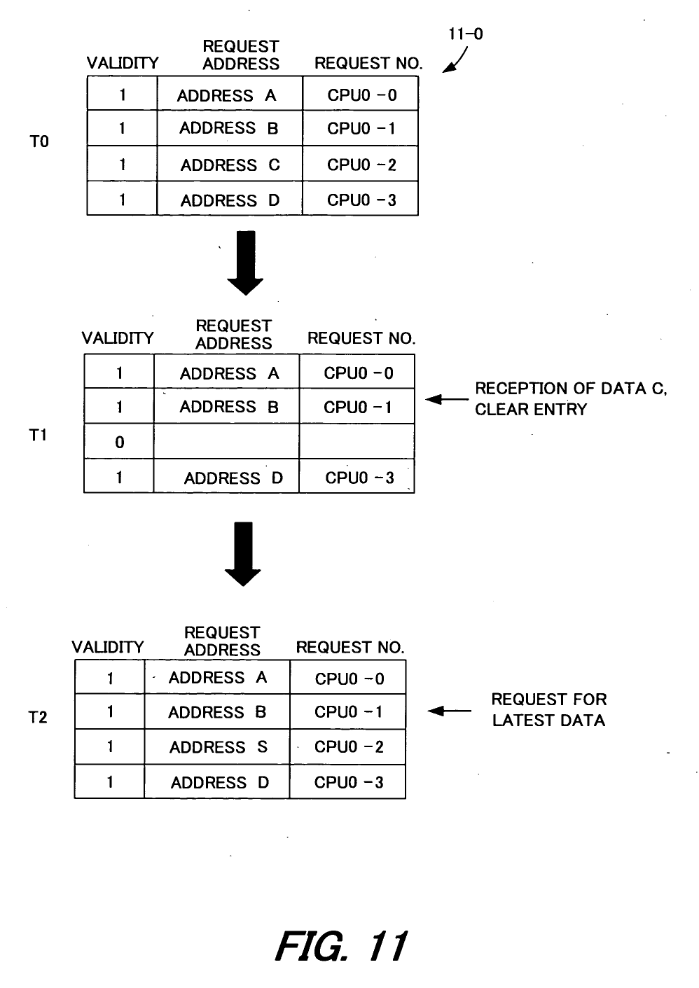

In the example shown in FIG. 10, each of the requesting buffers 11-0 to 11-2 of the processors CPU-0 to CPU-2 has a free entry. However, when the requesting buffer has no free entry, a new data request is suspended until a free entry is generated as shown in FIG. 11.

In FIG. 11, the time T0 indicates, for example, a state where all the entries in the reading request buffer 11-0 are in use when the processor CPU-0 executes the normal load instruction or the broadcast hint-included load instruction to cause a cache miss. Then, at the time T1, after data of a previous address C arrives to be written in the cache memory 10-0, the entry of the address C is cleared and the validity flag is reset to 0.

Thereafter, at the time T2, since a free entry is generated, the processor CPU-0 reads the address S corresponding to the suspended new reading request in the reading request buffer 11-0 to restart the processing that follows.

As described above, when each of the reading request buffers 11-0 to 11-2 does not have any free entry, a new reading request is suspended to wait until a free entry is generated. As a result, it can be ensured that the requested data is read in the cache.

Although the broadcast hint-included load instruction has been described above, the processing until the data transferred from the system control unit 2 is written to the cache memories 10-0 to 10-2 may be performed for the broadcast hint-included prefetch instruction. For the broadcast hint-included store instruction, the reading may be replaced by writing. Otherwise, the instructions may be processed in the same manner as described above.

### Second Embodiment

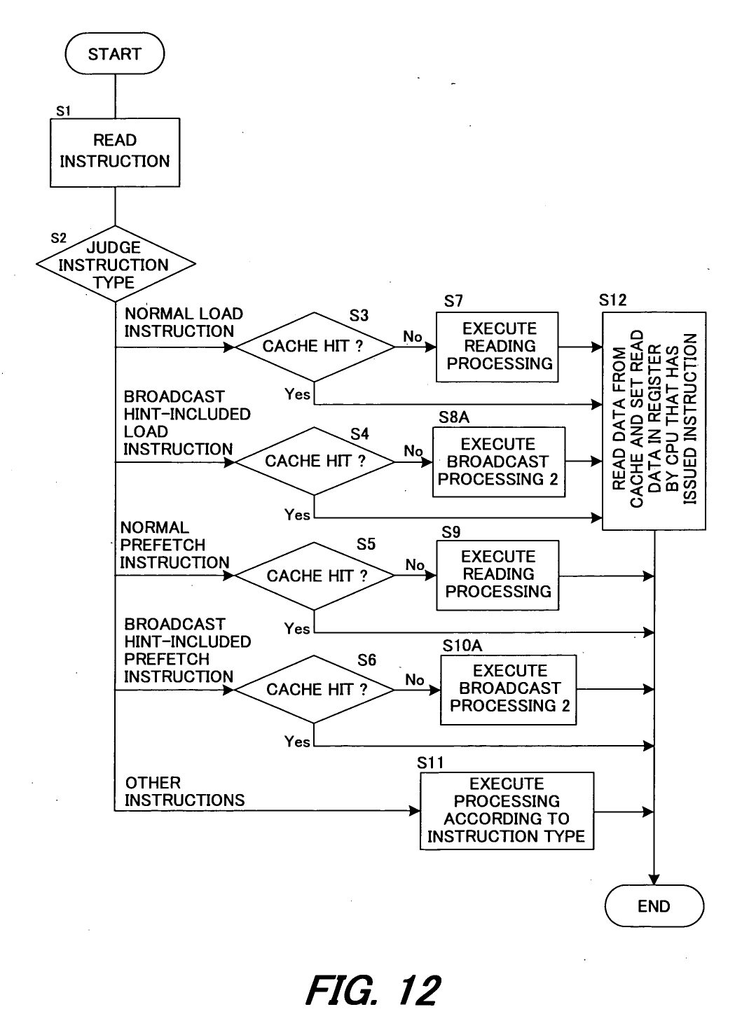

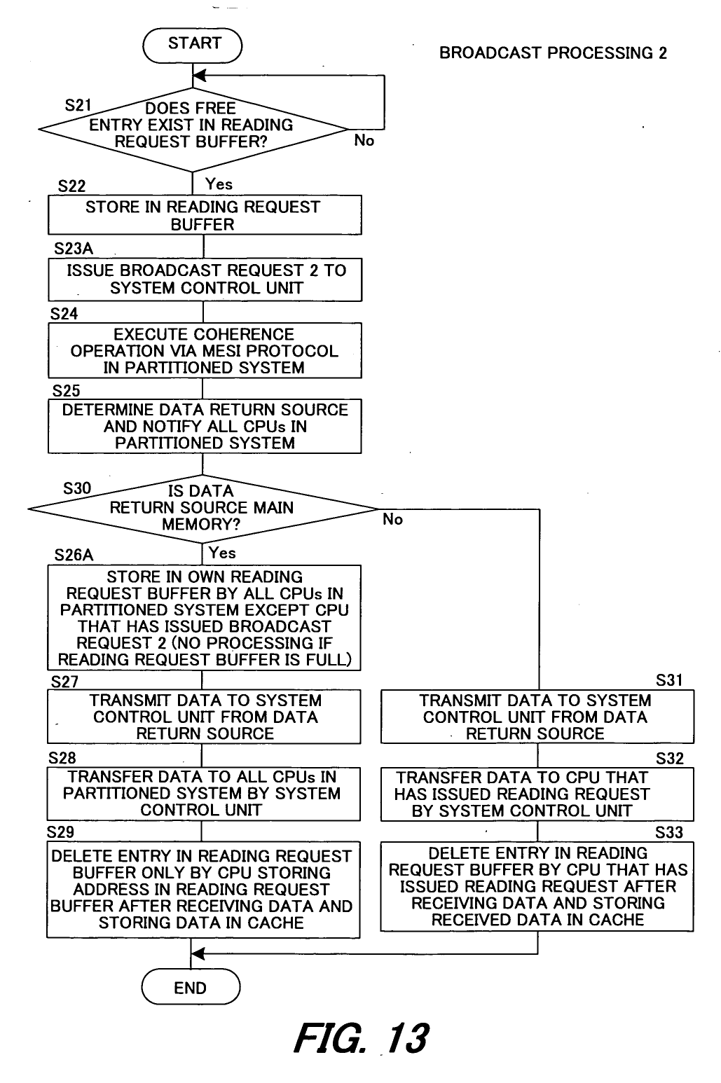

FIGS. 12 and 13 show a second embodiment where the broadcast processing 1 of the broadcast hint-included load instruction or the broadcast processing 1 of the broadcast hint-included prefetch instruction shown in FIG. 2 in the above-mentioned first embodiment is replaced by a broadcast processing 2. The other configuration is the same as that in the first embodiment.

FIG. 12 is a flowchart showing an example of the processing executed in the shared memory multiprocessor system shown in FIG. 1. In the flowchart shown in FIG. 2, S8 and S10 where the broadcast hint-included load instruction and the broadcast hint-included prefetch instruction result in a cache miss are replaced by the broadcast processing 2 indicated by Steps S8A and S10A. The other processing is the same as that of FIG. 2.

In the broadcast processing 2 in this second embodiment, when the broadcast hint-included instruction (load instruction or prefetch instruction) results in a cache miss, the cache line is not cached in all the processors in the same group. When the main memory 3 is accessed, the cache line is broadcasted to all the processors in the same group. However, when a requested cache line is cached in any one of the processors in the same group, the cache line is cached only in the self processor.

Specifically, in the broadcast processing 1 in the above-mentioned first embodiment, when a cache miss occurs, data at the same address (cache line) is always broadcasted to the processors in the same group. On the other hand, the second embodiment differs from the first embodiment in that broadcasting is not performed when any one of the processors in the same group caches the corresponding address and the data is transferred only to the self processor so as to be cached therein.

FIG. 13 shows a subroutine of the broadcast processing 2 executed in Steps S8A and S10A (the broadcast hint-included load instruction and the broadcast hint-included prefetch instruction) shown in FIG. 12. In the following description, the processor CPU-0 executes the broadcast hint-included load instruction.

In the broadcast processing 2 when the broadcast hint-included load instruction results in a cache miss, first, the processor CPU-0 judges in Step S21 whether or not the reading request buffer 11-0 has a free entry. When the reading request buffer 11-0 has a free entry, the processing proceeds to Step S22 to set the address in the main memory 3, which is requested to be read, in the reading request buffer 11-0. However, when the same address has already been set, the request is discarded without writing the address in the free entry. The processing of Steps S21 and S22 are the same as those in Steps S51 and S52 shown in FIG. 4.

Next, in Step S23A, the processor CPU-0 issues a broadcast request 2 for notifying the processors in the same group of the reading request for a predetermined address in the main memory 3 to the system control unit 2. In Step S24, as in Step S54 shown in FIG. 4 above, the system control unit 2 executes the coherence control of the cache memories in the same group.

Next, in Step S25, as in Step S55 shown in FIG. 4 above, the system control unit 2 judges the return source of the data of the address requested by the processor CPU-0 is the main memory 3 or another one of the processors which caches the data as a result of the coherence control and notifies the processors CPU-0 to CPU-2 in the same group of the return source.

Next, in Step S30, the system control unit judges which of the main memory 3 and the cache memories on the processors in the same group is the data return source. When the return source is the main memory 3, the processing proceeds to Step S26A. When the return source is the processor in the same group, the processing proceeds to Step S31.

When the return source is the main memory 3, in Step S26A, the broadcast request 2 issued by the processor CPU-0 is broadcasted to the processors in the same group. The processors CPU-1 and CPU-2 in the same group, which have received the broadcast request, set the address and the request No. of the broadcast request in free entries in their own reading request buffers 11-1 and 11-2.

The subsequent processing of Step S27 to Step S29 is the same as that in FIG. 5 in the above-mentioned first embodiment. In Step S27, the system control unit 2 receives the data at the corresponding address from the determined return source. Then, in Step S28, the system control unit 2 transmits the received data to all the processors CPU-0 to CPU-2 in the same group. In Step S29, among the processors CPU-0 to CPU-2 in the same group, which have received the data at the address requested by the processor CPU-0 from the system control unit 2, the data is stored in the cache memories 10-0 to 10-2 of the processors CPU-0 to CPU-2 which set the corresponding address in the reading request buffers 11-0 to 11-2. Then, each of the processors CPU-0 to CPU-2 deletes the content of the corresponding entry in each of the reading request buffers 11-0 to 11-2, updates the validity flag 111 to “0” and modifies the entry into an unused state, thereby completing the processing.

In the above-mentioned manner, when the return source is the main memory 3, the data (cache line) at the address requested by the processor CPU-0 is cached into all the processors in the same group.

On the other hand, in Step S31 where the return source is not the main memory 3, the processor in the same group transmits the data at the address requested by the processor CPU-0 to the system control unit 2. Then, in Step S32, the system control unit 2 transmits the data at the corresponding address only to the processor CPU-0 having issued the reading request. In Step S33, the processor CPU-0 having issued the reading request receives the data at the requested address from the system control unit 2 to store the received data in the cache memory 10-0. Thereafter, the processor CPU-0 clears the entry at the corresponding address in the reading request buffer 11-0, thereby completing the processing.

As described above, according to the second embodiment of this invention, for the load instruction or the broadcast hint-included prefetch instruction, when data at the address requested by one of the processors is in the main memory 3, the other processors in the same group will shortly need the data. Therefore, the data read from the main memory 3 is broadcasted to all the processors in the same group to be cached in all the processors in the same group. As a result, when the parallel processing is performed by a plurality of processors, data at the same address can be cached in all the processors in the same group by only one instruction. The performance for performing the SPMD or the like in the parallel processing can be improved.

On the other hand, when data at an address requested by one processor is cached in another one of the processors in the same group, the data is transferred from the processor holding the data only to the processor having issued the request. Therefore, data transfer to the processor already holding the data can be prevented. As a result, an unnecessary processing of the processor can be prevented to improve the processing performance.

As described above, according to the second embodiment of this invention, since data is broadcasted to all the processors only when the data is read from the main memory 3 into the cache memory 10-0 for the broadcast hint-included load instruction and the prefetch instruction with broadcast, the data can be efficiently cached only in the processor needing the data or the processor which will need the data shortly. As a result, the performance of the parallel processing via the SPMD and the like can be improved.

Although the broadcast hint-included load instruction and prefetch instruction have been described above, this embodiment can also be applied to the broadcast hint-included store instruction.

### Third Embodiment

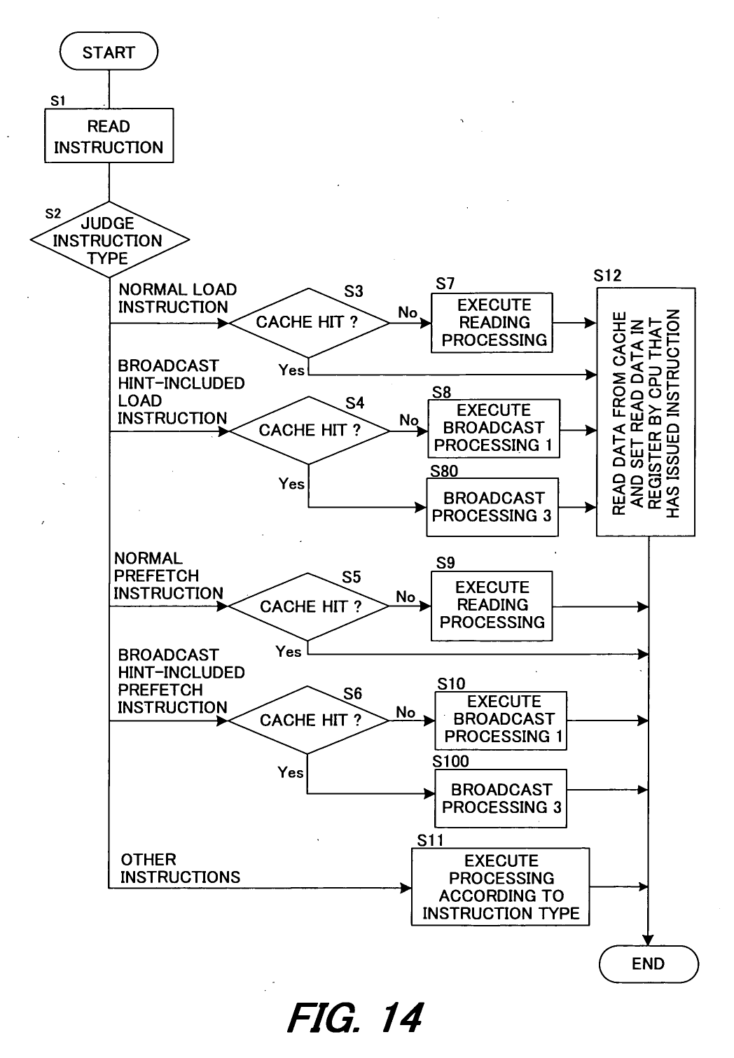

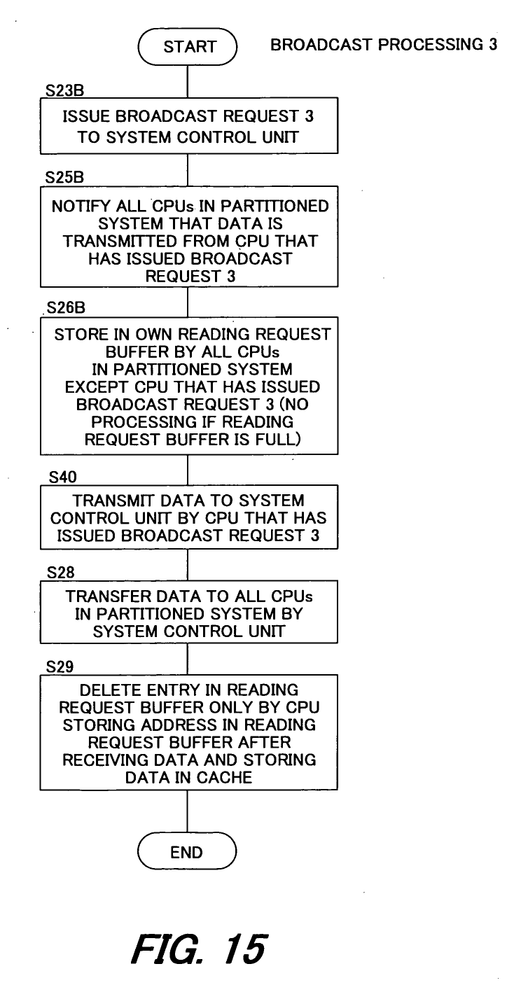

FIGS. 14 and 15 show a third embodiment. In the third embodiment, in addition to the broadcast processing 1 for the broadcast hint-included load instruction or the broadcast hint-included prefetch instruction shown in FIG. 2 in the above-mentioned first embodiment, a broadcast processing 3 is performed even in the case of a cache hit. The other configuration is the same as that in the first embodiment described above.

FIG. 14 is a flowchart showing an example of a processing executed in the shared memory multiprocessor system shown in FIG. 1. In the flowchart shown in FIG. 2, when the broadcast hint-included load instruction results in a cache hit, the broadcast processing 3 in Step S80 and S100 is executed. The other processing is the same as that in FIG. 2.

In this third embodiment, when the broadcast-hint included instruction (load instruction or prefetch instruction) results in a cache miss, the cache line is broadcasted to all the processors in the same group. When a cache hit occurs, cache-hit data is broadcasted to the other processors in the same group to be stored in their cache memories.

Specifically, in the parallel processing via the SPMD, since there is a high possibility that data used by one processor is also used by the other processors, cache-hit data is broadcasted to the other processors in the same group so as to prevent a cache miss from occurring in the other processors. The processing of Steps S80 and S100 are executed by any one of the processors in the same group. The other processors execute the same processing as that in FIG. 2 in the above-mentioned first embodiment. The following description shows a case where the processor CPU-0 executes the processing of FIG. 14.

FIG. 15 shows a subroutine of the broadcast processing 3 executed when the processor CPU-0 executes the broadcast hint-included load instruction or the broadcast hint-included prefetch instruction in Step S4 or S6 shown in FIG. 14 to result in a cache hit.

In FIG. 15, first, in Step S23B, the processor CPU-0 issues a broadcast request 3 to the system control unit 2. Next, in Step S25B, the system control unit 2 notifies all the processors in the same group that data is transferred from the processor CPU-0 having issued the broadcast request 3.

In Step S26B, among the processors in the same group, which have received the broadcast request 3, the processors CPU-1 and CPU-2 except for the processor CPU-0 issuing the broadcast request 3 register the address and the request No. of the data transmitted from the processor CPU-0 in free entries of the reading request buffers 11-1 and 11-2.

Next, in Step S40, the processor CPU-0 having issued the broadcast request 3 transmits cache-hit data to the system control unit 2. Then, in Step S28, the system control unit 2 transmits the received data to all the processors CPU-0 to CPU-2 in the same group.

In Step S29, the processors CPU-1 and CPU-2 in the same group, which have received data of the cache-hit address in the processor CPU-0 from the system control unit 2, store the data in the cache memories 10-1 and 10-2. Then, each of the processors CPU-1 and CPU-2 deletes the content of the corresponding entries in the reading request buffers 11-1 and 11-2, updates the validity flag 111 to “0”, and modifies the state of the entry into an unused state, thereby completing the processing.

As described above, when data used by one processor results in a cache hit, the data is transferred to the other processors in the same group. As a result, since there is a high possibility that the other processors also use the cache-hit data in the parallel processing via the SPMD, a cache miss can be prevented from occurring in the other processors to improve the performance of the parallel processing.

### Fourth Embodiment

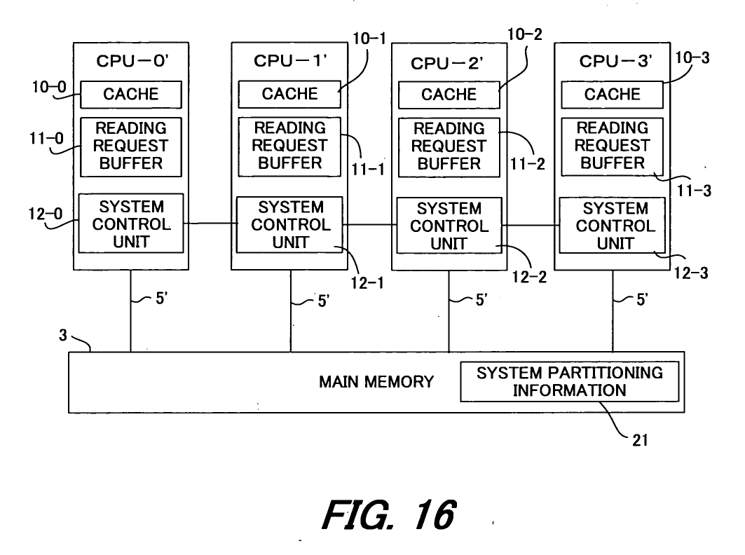

FIG. 16 shows a fourth embodiment which corresponds to a modification of the configuration of the computer shown in the above-mentioned first embodiment.

System control units 12-0 to 12-3 connected to the main memory 3 through a memory bus 5′ are respectively provided for processors CPU-0′ to CPU-3′. Each of the system control units 12-0 to 12-3 can access to the main memory 3 for each of the processors CPU-0′ to CPU-3′.

The system control units 12-0 to 12-3 are interconnected through a communication mechanism such as a crossbar so as to be able to communicate with each other. System partitioning information 21′ for grouping the processors CPU-0′ to CPU-3′ is stored in the main memory 3 so as to be referred to by each of the system control units 12-0 to 12-3. The cache memories 10-0 to 10-3 and the reading request buffers 11-0 to 11-3 of the respective processors CPU-0′ to CPU-3′ are the same as those in the first embodiment described above.

As described above, by providing the-system control units 12-0 to 12-3 respectively for the processors CPU-0′ to CPU-3′, access latency of the main memory 3 can be reduced to increase the speed of the processing.

<Notes>

In each of the above-mentioned embodiments, each of the cache memories 10-0 to 10-3 has been described as a single storage area. However, in the case of a processor provided with a plurality of levels of cache memories such as an L1 cache, an L2 cache, and an L3 cache, the broadcast hint-included load instruction, the broadcast hint-included prefetch instruction, and the broadcast hint-included store instruction according to this invention can be applied to the L2 cache memory or the L3 cache memory.

In each of the above-mentioned embodiments, for the broadcast hint-included load instruction or the broadcast hint-included prefetch instruction, the system control unit for broadcasting data to all the processors in the same group is shown as an example. However, the processor having issued the broadcast request may broadcast the data to the other processors in the same group.

While the present invention has been described in detail and pictorially in the accompanying drawings, the present invention is not limited to such detail but covers various obvious modifications and equivalent arrangements, which fall within the purview of the appended claims.

What is claimed is:

1. A processor, comprising:
an interface for performing communication with a main memory or one of another processor through a system control unit;
a cache memory for storing data of the main memory; and
a reading processing unit for reading data at an address contained in a reading instruction from the main memory to store the read data in the cache memory,
wherein the reading processing unit comprises:
a first load instruction executing unit for reading data corresponding to an address designated by a first load instruction from the main memory or the one of the another processor to store the read data in the cache memory; and
a second load instruction executing unit for reading data corresponding to an address designated by a second load instruction from the main memory or the another one of the processors to store the read data in the cache memory and requesting the system control unit to transmit the data to the another processor.

2. The processor according to claim 1, wherein, when the data corresponding to the address designated by the second load instruction is not stored in the cache memory, the second load instruction executing unit reads the data at the designated address from the main memory or the one of the another processor through the system control unit to store the data in the cache memory of the processor and requests the system control unit to transmit the data to the another processor.

3. The processor according to claim 1, wherein, when the data corresponding to the address designated by the second load instruction is not stored in the cache memory and the data corresponding to the address is stored in a cache memory of the another processor, the second load instruction executing unit reads the data at the designated address from the another processor through the system control unit to store the data in the cache memory of the processor; and when the data corresponding to the address is stored in the main memory, the second load instruction executing unit reads the data at the designated address from the main memory through the system control unit to store the data in the cache memory of the processor and requests the system controller to transmit the data to the another processor.

4. The processor according to claim 1, wherein:
when the data corresponding to the address designated by the second load instruction is not stored in the cache memory, the second load instruction executing unit reads the data at the designated address from the main memory or the one of the another processor through the system control unit to store the data in the cache memory of the processor and requests the system control unit to transmit the data to the another processor; and
when the data corresponding to the address designated by the second load instruction is stored in the cache memory, the second load instruction executing unit requests the system control unit to transmit the data in the cache memory to the another processor.

5. The processor according to claim 1, further comprising:
a cache control unit for storing the data received from the main memory or the one of the another processor through the interface in the cache memory; and
a request buffer for storing an address of the read data, wherein:
the reading processing unit stores the address in the request buffer upon reading of the data from the main memory or the one of the another processor; and
the cache control unit stores the data in the cache memory and deletes the address stored in the request buffer when the address of the received data and the address of the request buffer are identical with each other.

6. The processor according to claim 1, further comprising:
a cache control unit for storing the data received from the one of the another processor or the main memory through the interface in the cache memory; and
a request buffer for storing an address and a request No. of the read data, wherein:
the reading processing unit stores the address and the request No. in the request buffer upon reading of the data from the main memory or the one of the another processor; and
the cache control unit stores the data in the cache memory and deletes the address and the request No. stored in the request buffer when the request No. of the received data and the request No. of the request buffer are identical with each other.

7. The processor according to claim 1, further comprising a register for executing a computation processing,
wherein the data stored in the cache memory is set in the register.

8. A computer, comprising:
a plurality of processors, each comprising a cache memory; and
a system control unit connected to the plurality of processors, for controlling an access to a main memory or an access between the processors, wherein:
each of the processors comprises:
an interface for performing communication with the main memory or another one of the processors through the system control unit; and
a reading processing unit for reading data at an address contained in a reading instruction through the system control unit to store the read data in the cache memory;
the reading processing unit comprises:
a first load instruction executing unit for requesting the system control unit for data corresponding to an address designated by a first load instruction to store the data received from the system control unit in the cache memory; and
a second load instruction executing unit for requesting the system control unit for data corresponding to an address designated by a second load instruction to store the data received from the system control unit in the cache memory and requesting the system control unit to broadcast the data to the another processor; and
the system control unit transmits the data corresponding to the address to the plurality of processors when a broadcast request is made by the second load instruction executing unit.

9. The computer according to claim 8, wherein:
when the data corresponding to the address designated by the second load instruction is not stored in the cache memory, the second load executing unit reads the data at the designated address from the main memory or the one of the another processor through the system control unit to store the data in the cache memory of the processor and requests the system control unit to transmit the data to the another processor; and
the system control unit transmits the data to the plurality of processors based on the request.

10. The computer according to claim 8, wherein:
the system control unit comprises a judging unit for judging which of the cache memory of the another processor and the main memory stores the data corresponding to the address when the data corresponding to the address designated by the second load instruction is not stored in the cache memory;
the second load instruction executing unit reads the data at the designated address from the another processor through the system control unit to store the read data in the cache memory of the processor when the data corresponding to the address is stored in the cache memory of the another processor;
the second load instruction executing unit reads the data at the designated address from the main memory through the system control unit to store the data in the cache memory of the processor and requests the system control unit to transmit the data to the another processor when the data corresponding to the address is stored in the main memory; and
the system control unit transmits the data to the plurality of processors based on the request.

11. The computer according to claim 8, wherein:
the second load instruction executing unit reads the data at the designated address from the main memory or the one of the another processor through the system control unit to store the read data in the cache memory of the processor and requests the system control unit to transmit the data to the another processor when the data corresponding to the address designated by the second load instruction is not stored in the cache memory of the another processor, and requests the system control unit to transmit the data to the another processor when the data corresponding to the address designated by the second load address is stored in the cache memory; and
the system control unit transmits the data to the plurality of processors based on the request.

12. The computer according to claim 8, wherein:
the processor further comprises:
a cache control unit for storing the data received from the one of the another processor or the main memory through the interface in the cache memory; and
a request buffer for storing an address of the data to be read,
the reading processing unit stores the address in the request buffer upon reading of the data from the system control unit; and
the cache control unit stores the data in the cache memory and deletes the address stored in the request buffer when the address of the received data and the address of the request buffer are identical with each other.

13. The computer according to claim 8, wherein:
the processor further comprises:
a cache control unit for storing the data received from the one of the another processor or the main memory through the interface in the cache memory; and
a request buffer for storing an address and a request No. of the data to be read;
the reading processing unit stores the address and the request No. in the request buffer upon reading of the data from the system control unit; and
the cache control unit stores the data in the cache memory and deletes the address and the request No. stored in the request buffer when the request No. of the received data and the request No. of the request buffer are identical with each other.

14. The computer according to claim 8, wherein the processor further comprises a register for executing a computation processing and sets the data stored in the cache memory in the register.

15. The computer according to claim 8, wherein the system control unit comprises a system partitioning manager for grouping the plurality of processors, and upon reception of a broadcast request from the processor, transmits the data to all the processors in a group including the processor having issued the broadcast request.
